(19) United States
(12) Patent Application Publication
(10) Pub. No.: US 2007/0239755 A1
(43) Pub. Date: Oct. 11, 2007

(54) Methods and systems for messaging in a collaboration system

(75) Inventor: John J. Mahoney, Princeton Junction, NJ (US)

Correspondence Address: JLB CONSULTING, INC.;c/o INTELLEVATE, P.O. BOX 52050, MINNEAPOLIS, MN, 55402, US

(73) Assignee: Instant Information Inc.

(21) Appl. No.: 11/202,882

(22) Filed: Aug. 12, 2005

Related U.S. Application Data
(63) Continuation-in-part of application No. 11/184,596, filed on Jul. 19, 2005.
(63) Continuation-in-part of application No. 11/184,640, filed on Jul. 19, 2005.
(63) Continuation-in-part of application No. 11/184,362, filed on Jul. 19, 2005.
(60) Provisional application No. 60/642,685, filed on Jan. 10, 2005.
(60) Provisional application No. 60/642,685, filed on Jan. 10, 2005.
(60) Provisional application No. 60/642,685, filed on Jan. 10, 2005.

(51) Int. Cl. G06F 7/00

(52) U.S. Cl. 707/102

(57) ABSTRACT

Methods (300) and systems (100) for messaging in a collaborative environment (102) are disclosed. In one embodiment of the invention, metadata (500, 900) associated with a message (412) can be inherited from attachments to that message and/or bequeathed to discussions which includes that message. In this embodiment provision of discussions comprising related messages (406) and searches (1200) through the messages are thereby facilitated. In one embodiment of the invention, the system (102) of the current invention is operated by an application service provider.

### REFERENCE TO RELATED APPLICATIONS

This application is a continuation in part of co-pending U.S. patent application Ser. No. 11/184,596 titled METHODS AND SYSTEMS FOR ENABLING THE COLLABORATIVE MANAGEMENT OF INFORMATION USING PERSISTENT METADATA and of co-pending U.S. patent application Ser. No. 11/184,640 titled METHODS AND SYSTEMS FOR ENABLING THE COLLABORATIVE MANAGEMENT OF INFORMATION USING CONTROLLED ACCESS ELECTRONIC WORKSPACE, and of co-pending U.S. patent application Ser. No. 11/184,362 titled METHODS AND SYSTEMS FOR ENABLING THE COLLABORATIVE MANAGEMENT OF INFORMATION BASED UPON USER INTEREST, each of which were filed on Jul. 19, 2005 and each of which claims the benefit of U.S. Provisional Patent Application No. 60/642,685 filed on Jan. 10, 2005. The entirety of each of U.S. patent application Ser. Nos. 11/184,596, 11/184,640 11/184,362 and 60/642,685 are incorporated herein by reference.

This application is related to copending U.S. patent application application serial no. [attorney docket J112U006US00] titled METHODS AND SYSTEMS FOR PRESENCE MANAGEMENT IN A COLLABORATION SYSTEM and filed on same date herewith.

### FIELD OF THE INVENTION

The invention relates generally to information management and more particularly to a messaging system with well-tagged information.

### BACKGROUND OF THE INVENTION

Unlike their physical counterparts, the costs of digital packaging and electronic delivery of all types of information have moved very close to zero. Sending an email simply requires a digital connection between individuals—typically the Internet. Building a web site, publishing a blog, and sending an instant message are likewise virtually zero cost. Sharing of all types of data—files, news, photographs, audio, video and others—has become simple and essentially free.

This decrease in the complexities and costs associated with sharing data has given rise to an exponential increase in the amount of content available in any number of digital formats. Many different types of data are now freely shared over the Internet, for example: text, images, audio, video, multimedia combinations and others as will be known to the reader. Further, all of these different types of data can be packaged, transmitted and read in many different types of formats.

Each data type presents its own challenges with respect to sorting, finding and use by an end-user. For example, until recently, it has been nearly impossible to search audio and video files based on the content of those files. Even where the content of file types such as text are readily determinable and searchable, many different types of formats exist which must be processed and evaluated. While on the surface appearing beneficial, the efficiency and pervasiveness of digital data communications, and particularly Internet delivery, has in many cases eroded the value of the content being delivered by it.

Free e-mail systems such as Yahoo® Mail, Google gmail®, Hotmail® and others known to the reader enable everyone with access to a computer and the Internet to freely partake of electronic mail. File sharing systems such as Grouper®, Napster® and others known to the reader have been developed which enable users to share files. In recent times, blogs have become pervasive, enabling interested parties to easily and quickly post information for sharing with others. Specialized systems have been developed and are available for electronic sharing of specialized datatypes. Many known systems exist, for example, for sharing of: photographs, music, video and other information file types.

In addition to the challenge of searching and finding Internet-based data of interest, significant additional challenges arise once data is actually found and moved to a user's personal computer or workspace. Due to the extraordinarily large size and low costs of storage and data management capabilities available on a typical personal computer or workstation, the average user is able to download and store huge quantities of data and information. Once stored locally, organizing, retrieving and using personal computer-based data provides many of the same challenges as finding data on the Internet.

Without the constraint of real costs, the ability of individuals and other entities to generate and distribute content in all its expressions has far out-stripped any one individual's ability to discover, sort, identify and consume those items that may be useful or interesting to them.

Many different solutions have been developed for enabling users to sort large quantities of data to identify information of interest. Search engines, for example, search and index large quantities of Internet-based web pages, making the information both indexed to and searchable by a user. Google®, Yahoo®, A9® and others are examples of well-known commercially available Internet search engines. Similar search engines, for example Copernic™, X1™, and others have been developed for desktop users. Search engines, however, have many limitations. Much online information remains which is as yet unindexed by Internet search engines. Search engines return information in sorted order dependent on the particular algorithms employed by each engine. It is up to the end-user to search through the results provided by search engines, identifying particular information of relevance and interest. It thus becomes quite difficult and time-consuming to repetitively use search engines to find important business information.

Numerous online, searchable, subscription electronic databases have been developed which provide paid users the ability to search and access specialized types of information. Delphion®, for example, contains highly-specialized patent information available to subscription researchers. Reuters®, Bloomberg® and Thompson® are examples of multi-national information services corporations that provide highly-specialized information to subscription end-users in a variety of financial, legal, scientific and other industries.

The reader will thus appreciate many of the challenges associated with effectively finding, sharing and using electronic data in today's world.

While there have been discussed above the issues associated with finding and managing networked data and local data, yet another user environment exists which shares the challenges associated with both networked and local data. More particularly, “office” types of environments have become increasingly common wherein users obtain the ability to share data with other users, both geographically local and geographically disperse, in a virtual electronic office environment. Electronically-defined offices may comprise, for example, geographically local employees within a single organization, geographically disperse employees within a single organization, employees within multiple organizations linked for the purpose of accomplishing particular tasks, and/or combinations of all of these.

In addition to the above-described tools developed to facilitate individual data and/or communications types, integrated systems have been developed for use in the daily navigation of a typical office-type environment requiring finding, using and sharing multiple electronic data types. WorldStreet Corp., for example, is an example of an early financial services industry communications system. To the best knowledge of the present inventors, WorldStreet Corp. is no longer in operation.

Lotus Notes™ is another example of a collaborative, sharing type environment which enables authorized users to share various combinations of data and software applications, while also enabling user messaging capabilities. Existing collaborative software, however, presents many challenges. Lotus Notes™, for example, requires the installation of extensive local software as well as centrally-managed software. Further, this and other tools described herein below provide relatively limited functionality with respect to the ability to find, store, sort and use data.

Groove Virtual Office™ is another example of an information collaboration system enabling participants to collaborate in sharing data and information. To the best knowledge of the present inventors, Groove Virtual Office is an exchange-server based system, requiring central administration and set up. Because of its inherent structure, Groove Virtual Office is relatively limited in providing users the ability to easily find, share and use information. For further information, the reader is directed to www.groove.com.

Yet another example of a collaborative information tool is MindAlign on Connex™, a collaborative messaging tool that provides value added capabilities with respect to messaging and communications. To the best knowledge of the present inventors, MindAlign is relatively limited in operation to facilitating communications such as e-mail, instant messaging, audio and other types of person to person communications. For further information relating to MindAlign, the reader is directed to www.parlano.com.

Despite many of the available tools and services, finding useful information in the growing sea of content is a challenge. Many valuable items are simply never found, hidden beneath piles of spam and other marginal content. A great deal of unique and interesting content remains un-indexed, even by large search engines. That which is indexed is usually not categorized in very meaningful ways, and is often crowded out by similarly indexed sources, most of which are irrelevant to the individual searching for content. Even content which is found and subsequently moved to a local computing system often becomes lost and unavailable for future use.

### SUMMARY OF THE INVENTION

The present invention provides collaborative information discovery, sharing, management and use capabilities that overcome many of the challenges and limitations of the prior art. More particularly, the present invention provides a feature-rich messaging system for managing different formats of related communications and accretive metadata associated therewith.

In accordance with one embodiment of the present invention, there are provided methods and systems for communicating, one exemplary method comprising: receiving a first communication from a requesting entity; determining any participating entities to whom said first communication is to be made available; storing said received first communication and metadata relating at least to said determined participating entities; and making said stored first communication available to said determined participating entities.

### DESCRIPTION OF THE DRAWING FIGURES

These and other objects, features and advantages of the present invention will be apparent from a consideration of the following Detailed Description of the Invention when considered with the drawing Figures, in which:

FIG. 1 is a block diagram showing one example of a hardware configuration of a collaboration system, according to an embodiment of the present invention;

FIG. 2 is a block diagram of the messaging tools, according to an embodiment of the present invention;

FIG. 3 is a flowchart of a method for of making a communication available to one or more entities, according to an embodiment of the present invention;

FIG. 4 illustrates a graphical user interface, or GUI, for making a communication available, according to an embodiment of the present invention;

FIG. 5 illustrates a graphical user interface for inputting information on an entity, according to an embodiment of the present invention;

FIG. 6 illustrates a graphical user interface for inputting a message in a new discussion, according to an embodiment of the present invention;

FIG. 7 illustrates a graphical user interface for selecting a participating entity and category for the message of FIG. 6, according to an embodiment of the present invention.

FIG. 8 illustrates a graphical user interface listing a partial directory of assets, according to an embodiment of the present invention;

FIG. 9 illustrates a graphical user interface of an asset profile, according to an embodiment of the present invention;

FIG. 10 is a block diagram of presence management tools, according to an embodiment of the present invention;

FIG. 11 is a flowchart of a method for managing presence, according to an embodiment of the present invention; and

FIG. 12 is a flowchart of a method for searching for messages, according to an embodiment of the present invention.

### DETAILED DESCRIPTION OF THE INVENTION

The present invention provides a workspace collaboration system which improves upon the way people discover, share, manage, and use information. As will be apparent from a consideration of the detailed description of the invention set out below, amongst other features and advantages, the present invention:
offers well tagged communications. As used herein, the term “tags” and the term “metadata” are interchangeable.
supports metadata persistence regardless of how information is used (e.g.—if a document is sent as an attachment to a communication, the tagging associated with the document is carried in the communication as well as the document itself and the tags associated with the sender and recipients.)
supports interactions and exchanges between individuals both within a single firm/company and cross-firm/company
supports the tagging of sent communications with recipient advertised tags
allows individuals to control who has access to them
allows individuals to organize information they discover into a structure that reflects their view of its utility and context
allows individuals to organize into teams that can discover and share content collectively in ‘workspaces’—a combination of content, people and application assets organized around the needs of the team and linked contextually.

As used herein, the phrase “for example,” “such as” and variants thereof describing exemplary implementations of the present invention are exemplary in nature and not limiting.

Description of the System

For purposes of facilitating a description of an embodiment of the present invention, an illustrated embodiment of the invention will now be described with respect to the following general functions:
a description of the hardware components and interconnections of a workspace collaboration system,
a description of messaging within the collaboration system, and
a description of presence management within the collaboration system.

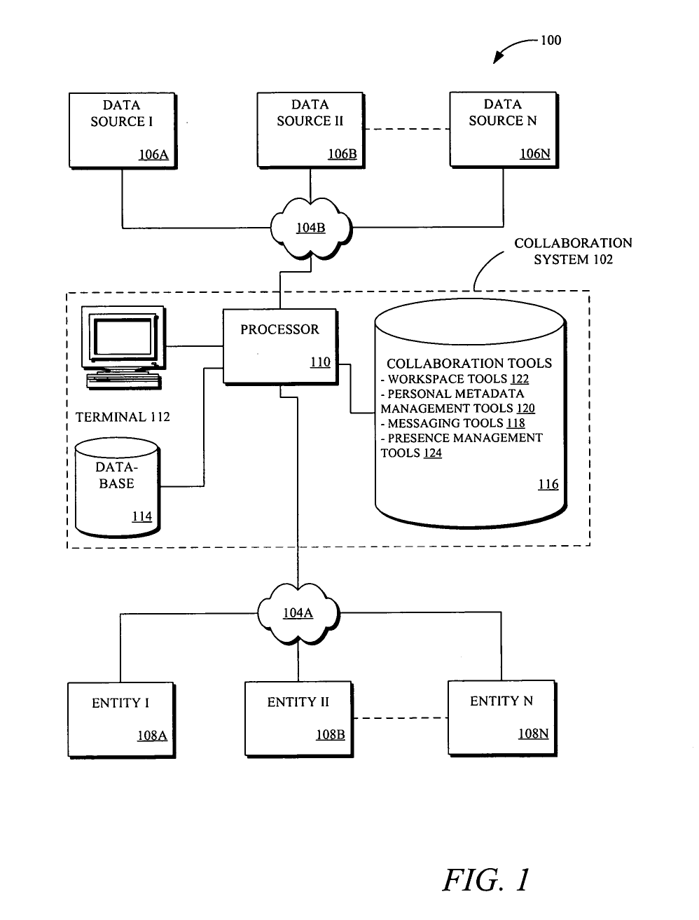

With reference now to FIG. 1, there is shown a system 100 including a workspace collaboration system 102. Workspace collaboration system 102 is connected through an appropriate network interfaces 104A to a series of external entities, three of which are indicated at 108A, 108B, 108N. Optionally, workspace collaboration system 102 is connected through an appropriate network interface 104B to a series of external data sources, three of which are indicated at 106A, 106B, 106N. Shown in simplified format for purposes of explanation, collaboration system 102 is seen to include a processor 110 connected to a user terminal 112, a database 114, and a set of software collaboration tools indicated at 116. Collaboration tools 116 optionally include one or more of the following inter-alia: messaging tools 118, personal metadata management tools 120, workspace tools 122, and presence management tools 124.

In the described embodiment of the invention, collaboration system 102 is operated by an application service provider (ASP), a configuration well known to the reader.

Many different configurations will be known for system 102, capable of performing the functions described herein. For example, system 102 may comprise a conventional server or a mainframe computer connected to a network such as the Internet through network connections 104. Similarly, terminal 112 comprises a conventional user interface to system 102. Database 114 comprises an appropriate arrangement of magnetic, semiconductor, optical and other appropriate types of memory. Collaboration tools 116 comprise tools, for example software tools stored in database 114 or otherwise configured in the firmware or hardware of system 102 and operable by user entities 108, configured to perform the functions described herein.

As will be understood by the reader, collaboration system 102 is shown in simplified format for purposes of describing the invention. For example, the system may comprise multiple co-located and/or geographically diverse systems, interconnected in one of many well-known configurations. Similarly, numerous ones of each of the described components may be included in the system.

Depending on the embodiment, entities 108A-N represent as appropriate individuals, groups of individuals, members of a collaborative workspace (as described below), companies, organizations, a combination of the above (for example one entity is an individual and the other entity is a group of individuals), etc. For example in one embodiment, entities represent conventional human users operating through appropriate user-interfaces, for example comprising personal computers, portable user devices such as laptop computers and/or personal information devices and other devices capable of communicating over the network 104 with collaboration system 102. As will be described in further detail herein below, entities 108A-N are configured to have conventional computing and communication capabilities, such as: e-mail, VOIP telephony, instant messaging, and others as are known to the reader.

In accordance with the illustrated embodiment of the present invention, entities 108A-N access collaboration system 102 through the Internet. As noted above, in the described embodiment, collaboration system 102 is operated as a “turn-key” system by an ASP. Navigating in a conventional manner to a web page transmitted through the network by collaboration system 102, an entity will download and interact with a series of web pages, or graphical user interfaces (GUI) providing the capabilities, functionalities and processes described herein below.

Optionally, data sources 106A-N comprise one or more of many external data sources, for example news and information channels.

It will be appreciated that, in accordance with a significant advantage of the present invention, collaboration system 102 is developed and maintained by the ASP remotely from the external entities, relieving the entities of obligations and responsibilities for developing and maintaining the system, while still providing the entities with significant customizable functionality. Again, the details of this functionality are described herein below.

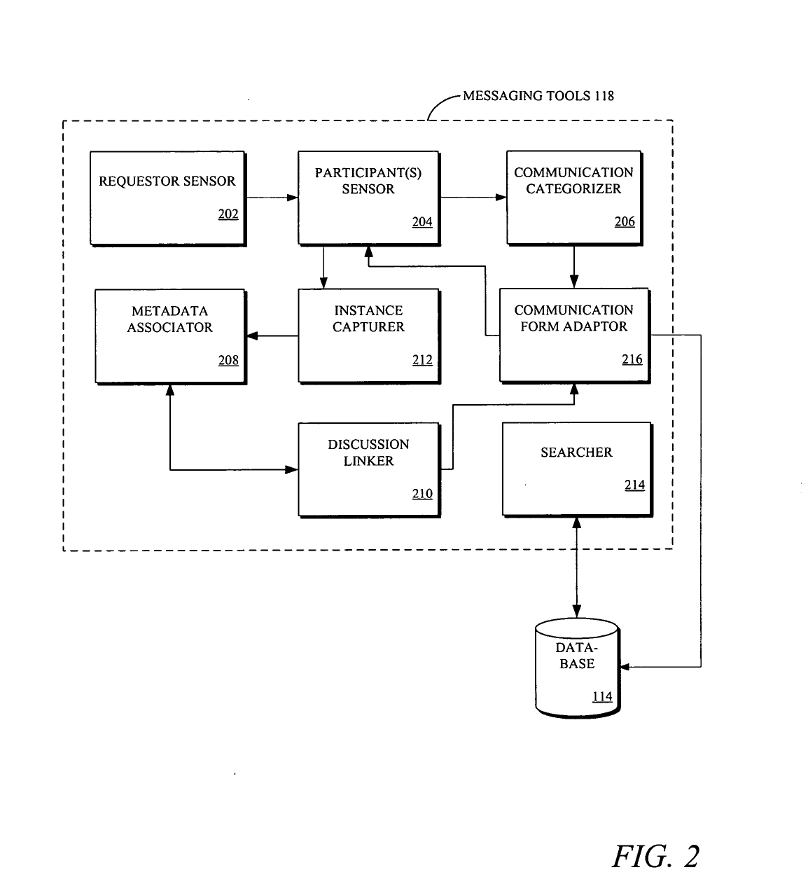

FIG. 2 is a block diagram of messaging tools 118, according to an embodiment of the present invention. Messaging tools 118 can be made up of any combination of software, hardware and/or firmware that performs the functions as defined and explained herein. In the illustrated embodiment, messaging tools 118 include a requester sensor 202, a participant(s) sensor 204, a communication categorizer 206, a metadata associator 208, a discussion linker 210, an instance capturer 212, a searcher 214, and a communication form adaptor 216. Each of modules 202, 204, 206, 208, 210, 212, 214, and 216 can be made up of any combination of software, hardware and/or firmware that performs the functions as defined and explained herein. The division of messaging tools 118 into the modules shown in FIG. 2 is for ease of understanding and in other embodiments any illustrated module may be separated into a plurality of modules or alternatively combined with other modules. In other embodiments, messaging tools 118 may include one or more other modules illustrated or not illustrated in FIG. 1 as being elsewhere in system 100. For ease of understanding modules 202, 204, 206, 208, 210, 212, 214, and 216 have been presented as being a part of messaging tools 118, but in other embodiments any of modules 202, 204, 206, 208, 210, 212, 214, and 216 may be integrated with workspace tools 122, personal metadata management tools 120, presence management tools 124, and/or processor 110 and/or database 114.

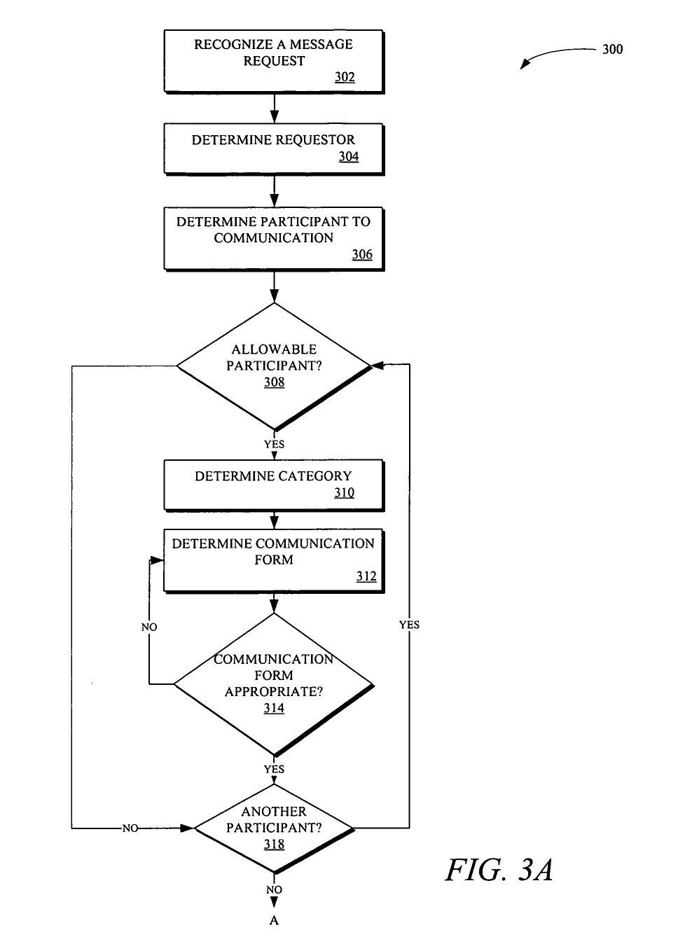

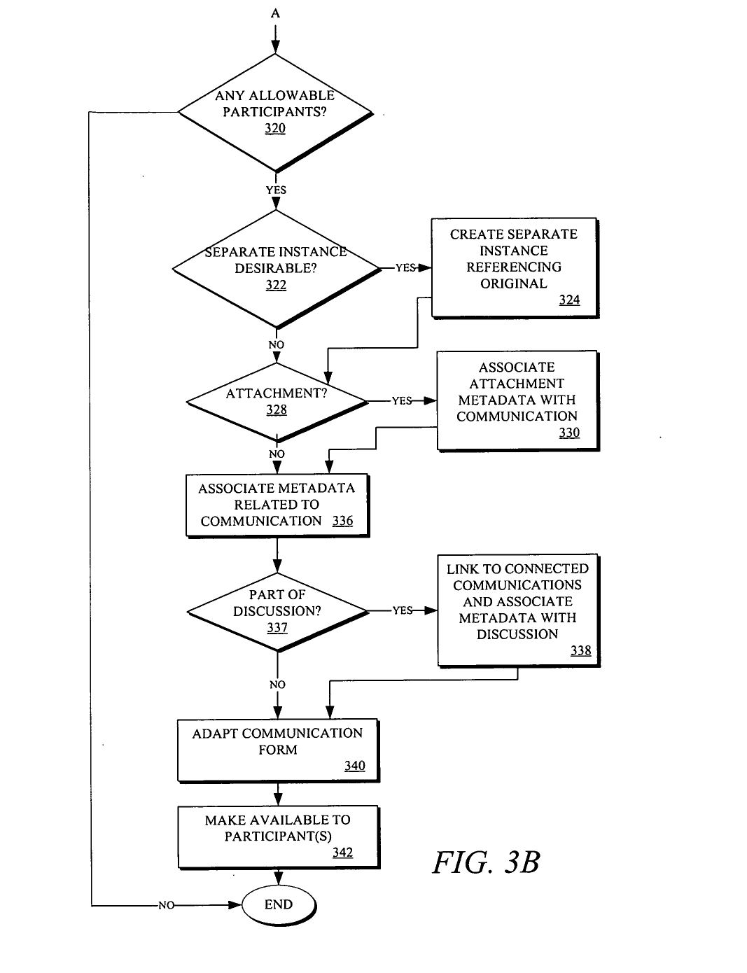

FIG. 3 is a flowchart of a method 300 of making a communication available to one or more entities, according to an embodiment of the present invention. In the illustrated embodiment, method 300 is performed by workspace collaboration system 102. The invention is not bound by the specific stages or order of the stages illustrated and discussed with reference to FIG. 3. For example, two or more stages of method 300 may occur simultaneously. It should also be noted that alternative embodiments can include only selected stages from the illustrated embodiment of FIG. 3 and/or additional stages not illustrated in FIG. 3.

In stage 302, a message request from a requesting entity is recognized. For example, a request to communicate may be received via network interface 104A using one or more GUI interfaces and recognized by requestor sensor 202. The message request can be for example for a new message unconnected to any previous messages or for a message connected to at least one previous messages (for example reply, forward, etc)

In stage 304, the requesting entity (“requester”) and optionally one or more relevant characteristics of the requester are determined, for example by requestor sensor 202. For example, in one embodiment, a relevant characteristic of the requestor includes whether the requester is currently working in a private workspace or in a collaborative workspace as will be discussed in further detail below.

In stage 306, one participating entity (“participant”) to the communication is determined and optionally one or more relevant characteristics of the participant, for example by participant(s) sensor 204. The participating entity(ies) are those entities to whom the communication should be made available. Participants may be identified by any one or more means, depending on the status(es) of the means at the time of the communication. For example, in one embodiment, if the requester is currently working in a collaborative workspace when making the message request, the participating entit(ies) are assumed to be all member(s) of the collaborative workspace. Continuing with this example, the requestor may not have to specify any participants if the request is made while working in a collaborative workspace because all members may be automatically designated as participant(s). Still continuing with this example, if instead the request is made while working in a private workspace the requestor may have to specify at least one participating entity for a new message unconnected to previous messages because there may not be any default participating entities (other than perhaps the requester). In another embodiment, the requestor may always have to specify participant(s) for a new message regardless of which workspace the requestor is currently working in.

In yet another embodiment, for a message connected to a previous message, the participant(s) in some cases may be pre-selected based on the type of message and would not need to be specified by the requestor. For example a “reply” message may pre-select the participant(s) based on the previous connected message. As another example, a requestor may restrict a new message and subsequent discussion to specified participating entities, so that any messages connected to the new message (for example, reply, forward, etc.) can not include participating entities other than those specified by the original requester.

Typically although not necessarily, the requestor is automatically considered a participant and therefore does not have to be specified.

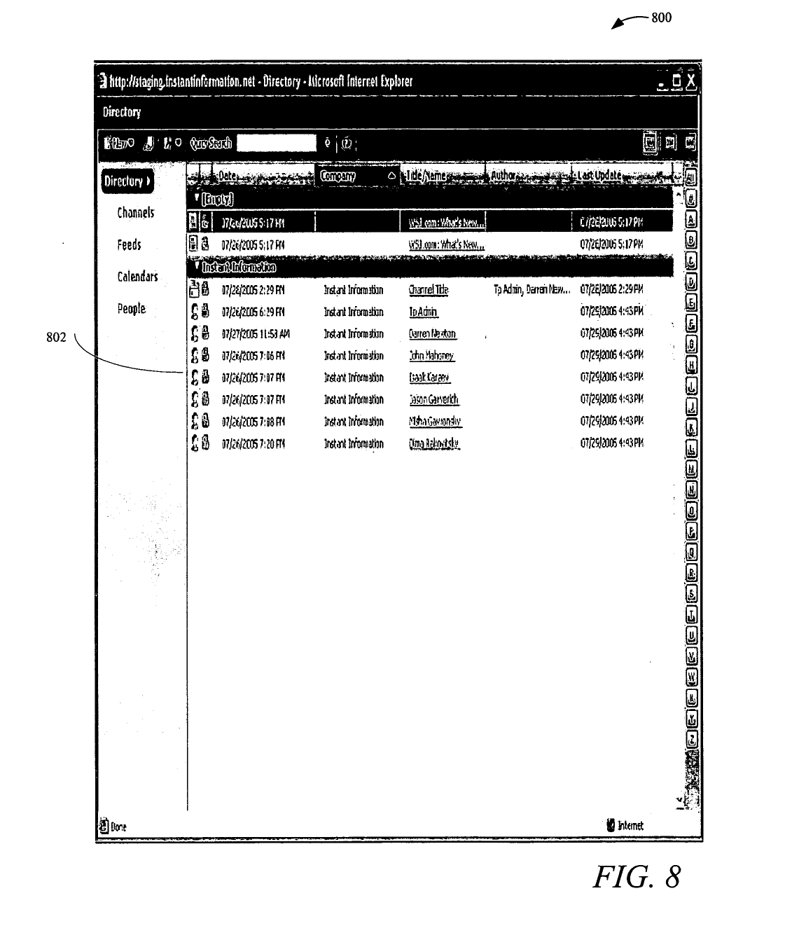

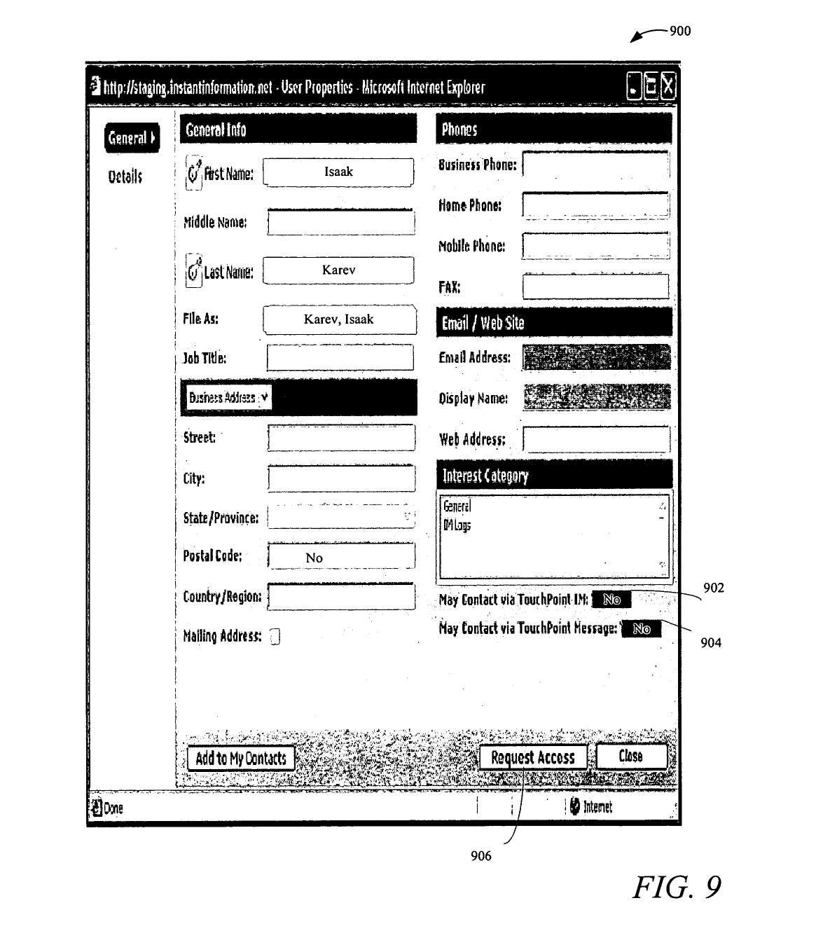

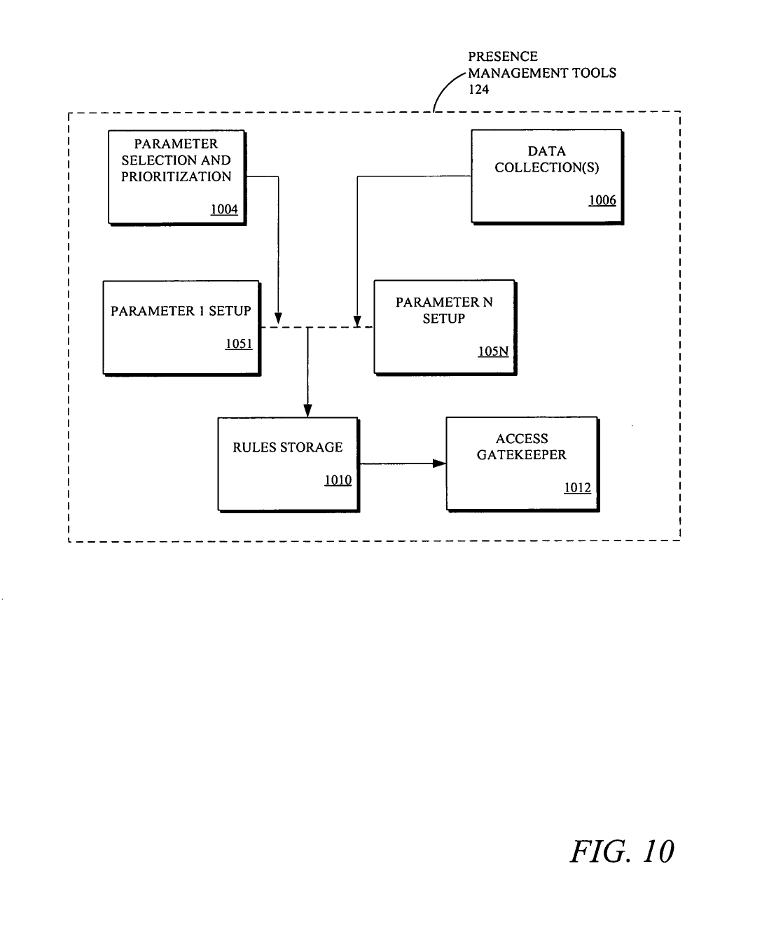

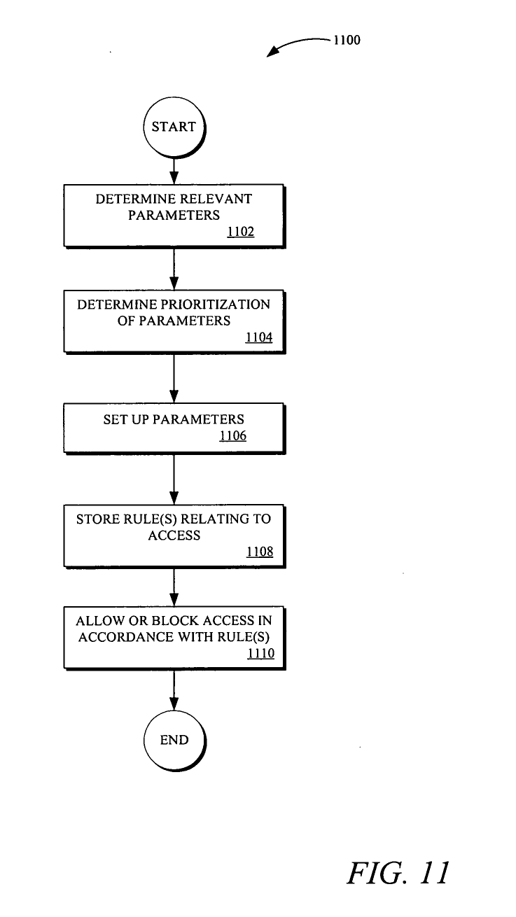

In optional stage 308, it is decided whether the determined participating entity is allowable, for example by participant sensor 204. For example, assuming the requestor specifies a participant to whom access by the requestor is not permitted, in one embodiment the participant would be considered not allowable. Further below with reference to FIGS. 8 and 9 will be described methods and systems according to one embodiment for requesting access to entities so as to be allowed to communicate with those entities. As another example, assuming the requestor specifies a participant who under the conditions prevailing at the time of the request does not want to be accessed by the requestor, in one embodiment the participant would be considered not allowable. Further below with reference to FIGS. 10 and 11 are described presence management methods and systems according to one embodiment for specifying under what conditions access to a participant is allowable or not allowable.

In one embodiment where the requestor is also considered a participating entity, the requester participating entity is not necessarily evaluated for allowability in stage 308 because it is assumed that a requestor can always access itself.

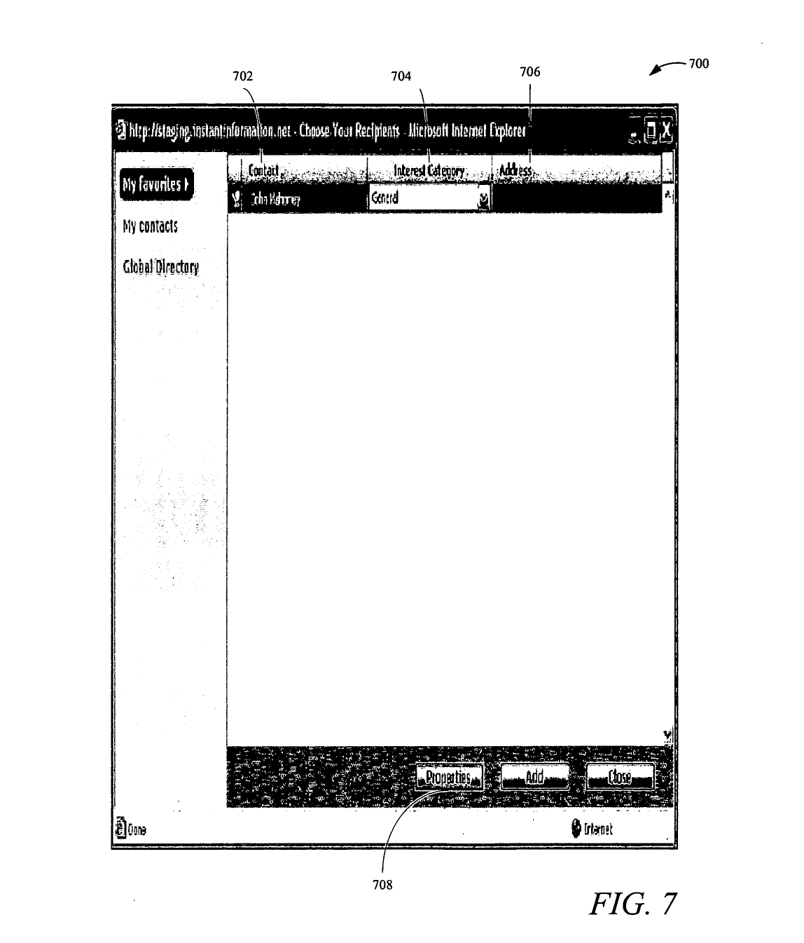

In an alternative embodiment where only allowable participants can be entered by the requestor in stage 306, for example only participants included in “contacts” (see below description of column 702 in FIG. 7), stage 308 may be omitted because any participants which collaboration system 102 accepts as input are necessarily allowable.

In an embodiment where participants are predefined by collaboration system 102 and therefore inherently allowable, for example in some cases because the request was made while in a collaborative workspace, for example in some cases because of the type of the communication (for example a reply communication), or for example in some cases because of a restriction on participating entities set by the requestor of a new communication for subsequent connected communications, stage 308 can be omitted. It will be understood by the reader that the participant approval function provided by stage 308 may be desirable, for example, for security purposes so as to keep system 102 and the information contained therein restricted to approved entities.

In alternative embodiments, stage 308 is omitted and there is no check for allowability either for any messages or for selected messages. In these alternative embodiments, all entities are considered “allowable” for all messages or for the selected messages. Depending on the embodiment the basis for selecting which messages are not checked for allowability can be system determined, determined by the requester, determined based on past patterns, etc. For example in one of these embodiments, assume that at the present time certain entities do not want to receive instant messages from a requester (i.e. these certain entities are not available). Continuing with the example, instead of checking for allowability in stage 308, in another embodiment the requestor is permitted to invite both entities that are available and invitees that are not currently available to an instant message session. Entities that are available participate in a real time discussion. When the instant message session ends, or after a predetermined period, a transcript of the session (i.e. a time-shifted discussion) may be made available to all invitees, or alternatively to all invitees which actually participated. For example the transcript may be in the form of a threaded message.

If the determined participant is not allowable then method 300 continues with stage 318 where another participant is determined and evaluated for allowability, or alternatively method 300 ends because there are no allowable participants or because there are no allowable participants other than the requestor.

If the participant is determined to be allowable in stage 308 or stage 308 was omitted, method 300 continues with 310.

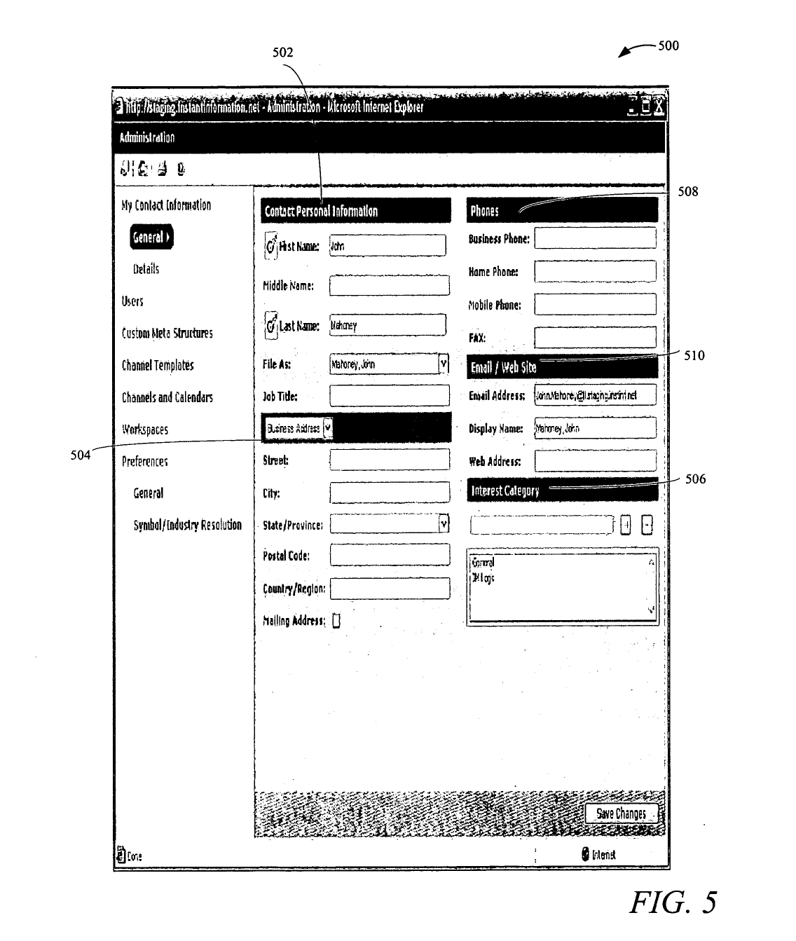

In optional stage 310, the category of the communication is determined, for example by communication categorizer 206. For example, in some embodiments, the requestor when specifying the participating entity can select a category for the communication. In one of these embodiments, the category selected is one of one or more (interest) categories predefined by the participating entity. Further below with reference to FIG. 5 will be described methods and systems according to one embodiment for defining the interest categories. In some embodiments, stage 310 may be omitted, for example in an embodiment where categories are not defined for messages requested while the requestor is in a collaborative workspace. As another example stage 310 may be omitted in some cases if the communication by default inherits the category of a connected previous communication. As another example stage 310 may be omitted in some embodiments if the participating entity is the requestor. It will be understood by the reader that in an embodiment of the invention where the requestor selects the category, the job of content classification is placed on the requester, which is advantageous over systems which place the burden on the participating entity, forcing the participating entity to discriminate and classify with no foreknowledge of the contents purpose or composition.

In stage 312, the form of the communication is determined, for example by communication form adaptor 216. For example, in one embodiment, a communication can be in the form of electronic mail, instant messages, VOIP telephony, etc. Depending on the embodiment, the form of the communication can be specified by the requester and/or can be inferred from the communication. In one embodiment, the form of a communication which is connected to a previous communication is restricted to be the same form as the previous communication. In another embodiment, the form of the communication is assumed to be the same as the connected previous communication but can be overridden by the requestor. In yet another embodiment, the requestor needs to specify the form for the communication or the form has to be inferred from the communication irrespective of whether the communication is connected to a previous communication. In the latter two embodiments the form of each connected communication need not necessarily be the same. As will be seen below, the communication form may be used in managing the communication and its sharing with others.

In optional stage 314, it is determined whether the communication form is appropriate for the participant, for example by participant sensor 204. For example, assume the requestor is allowed to communicate with the participant but only using predefined forms of communication. Continuing with the example the approved predefined forms of communication may be valid under any conditions or may be valid based on the conditions prevailing at the time of the communication request. Further below with reference to FIGS. 8, 9, 10, and 11 are described methods and systems according to one embodiment for defining appropriate forms of communication. If the communication form is not appropriate for the participant then optionally the requester may specify another communication form in a repeat of stage 312 and the other communication form will be evaluated for appropriateness in a repeat of stage 314. Alternatively if the first form of communication was not appropriate for the participant (stage 314), that participant is blocked, the requestor is optionally notified of the block and reason for the block, and method 300 proceeds directly to stage 318. Alternatively, if the first form of communication is not appropriate, method 300 may proceed with stage 318, and the communication may be converted into an appropriate communication form, for example in stage 340 (see below).

In an alternative embodiment, only an appropriate form of communication can be selected/used by the requestor and therefore stage 314 is unnecessary and may be omitted.

In embodiments where all forms of communication are appropriate provided the participant is an allowable participant, stage 314 may be omitted.

In an embodiment where the form of a communication which is connected to a previous communication is restricted to be the same form as the previous communication and is consequentially appropriate, state 314 may be omitted for any subsequent connected communications.

In one embodiment if the participating entity is the requestor, stage 314 may be omitted if all forms of communication are considered appropriate for oneself.

Continuing with respect to FIG. 3, in stage 318, it is determined if there is a different participant entity not previously determined in stage 306 (or in previous iterations of stage 318), for example by participant(s) sensor 204. Optionally, one or more relevant characteristics of the participant may also be determined. For example assuming a group of individuals as the participating entity, in one embodiment, the requestor could have specified more than one individual in stage 306 by selecting an entry corresponding to the group of individuals as the participating entity, or for example by replying to a group of individuals, whereas in a different embodiment, one of the group of individuals can be specified in stage 306 and a different one specified in each iteration of stage 318.

If there is a different participant entity (“yes” to stage 318), stages 308 to 314 are repeated. Otherwise method 300 continues with stage 320.

In stage 320 it is determined, for example by participant(s) sensor 204, if there is at least one allowable participating entity or alternatively at least one allowable participating entity other than the requestor and if not method 300 ends. If there is at least one allowable participating entity (or at least one allowable participating entity other than the requester), method 300 continues with stage 322.

In optional stage 322 it is determined if one or more separate instances of the communication is desirable. In some embodiments, a separate instance of a communication may be desirable if there is a reason not to execute stages 328 through 342 on the actual communication. It will be understood that an instance of a communication refers to the content of the communication and that a separate instance comprises the content of the communication managed separately and potentially with different attachments, metadata or handling. If one or more separate instances is desirable then in stage 324, one or more separate instances of the communication is made which references the actual communication, for example by instance capturer 212. If one or more separate instances is created, then in some embodiments stages 328 through 342 are executed on the one or more separate instances rather than on the actual communication. For ease of description, the description below will refer to communications, not differentiating between separate instances and actual communications, because any instance transparently references the actual communication and the same GUIs are typically although not necessarily used in either event. Stages 322 and 324 may be omitted in embodiments where separate instances are not created.

In optional stage 328, it is determined if there are one or more attachments to the communication. In one embodiment, attachments include digital packages and basic descriptive metadata. If there is an attachment(s), the metadata related to the attachment(s) is associated with the communication in stage 330, for example by metadata associator 208. The related metadata can include for example attachment content, text indices of any attachments (where possible) and/or metadata associated with the attachments.

In an embodiment where metadata is not inherited from attachments, stages 328 and/or 330 may be omitted.

In an alternative embodiment, separate instance of attachments may be created which references the actual attachment, for example by instance capturer 212, and similar systems and methods to those described herein may be used mutatis mutandis.

In stage 336, metadata related to the communication is associated with the communication, for example by metadata associator 208. (Since above with reference to stage 330, meta-data related to attachments was discussed, in this stage only other types of meta-data related to the communication are discussed). The associated metadata may include one or more of the following inter-alia: subject content, title content, message body content, a text index of the message, keyword, synopsis, any standard tags such as industry classification, ticker codes, etc, meta-data related to the requesting entity, meta-data related to the participating entity (ies), event(s) that have the same class of metadata and time and location related meta-data (where is the event, when is the event, who is participating, event collateral, phone numbers, etc), etc. Other meta-data will be known to the reader. Some methods and systems for defining metadata for (requesting and/or participating) entities according to one embodiment are elaborated on further below with reference to FIG. 5.

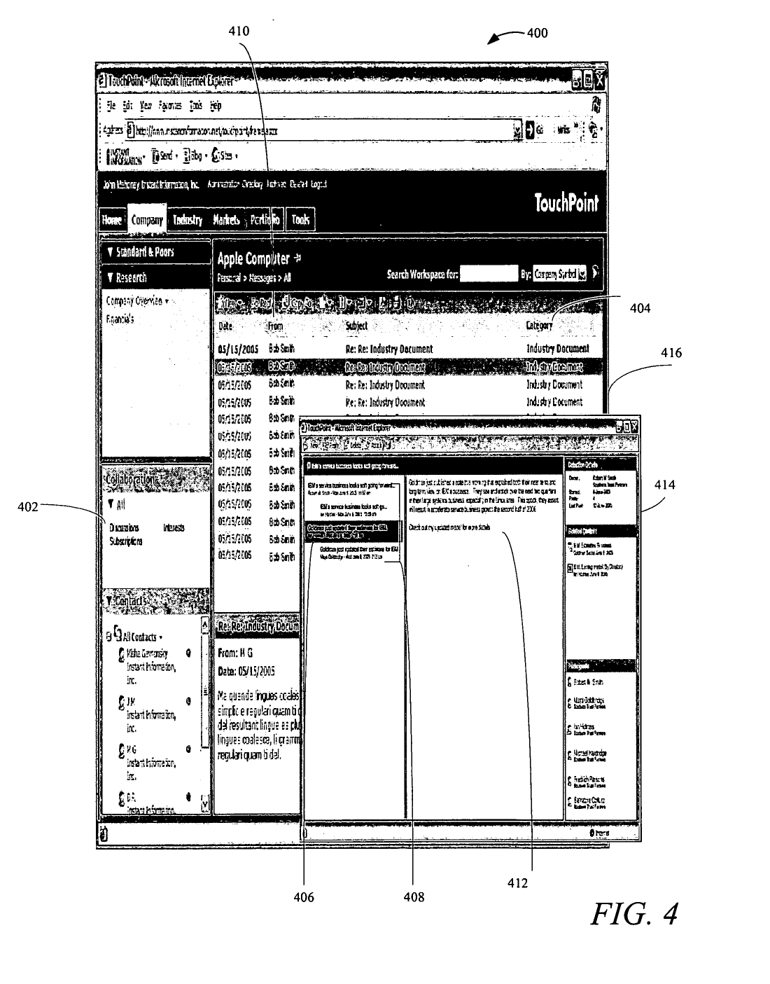

In optional stage 337, it is determined if the communication is part of any pre-existing discussions, i.e. connected to one or more previous communications. For example, the requestor may have specified the communication as being part of a discussion by replying or forwarding a previous communication. In stage 338, the communication is linked with any connected communications and attachments, for example by discussion linker 210. For example, in one embodiment the communication references all other connected communications so that when the communication is made available in stage 342, the connected communications are also made available, although not necessarily in the same fashion as the communication. For example see below FIG. 4. As another example, the linked communications may be accessible by clicking a button “linked messages” when viewing the communication. Depending on the embodiment, the linked messages may be required to be in the same form (for example email, instant message, IP telephony, etc.) or may not be required to be in the same form. If there are no connected communications, stage 338 may be omitted. In accordance with a feature of the present invention, communications of different types such as emails and instant-message communications may be linked, or threaded. In this manner all communications pertinent to a topic or person or discussion may be linked regardless of communication type.

In addition in stage 338, metadata that was associated with the communication in stage 330 and/or 336 is also associated with any pre-existing discussions to which the communication belongs, for example by metadata associator 208. Therefore context is inherited in an accretive fashion by the total discussion as each linked communication is created. Individual messages within a discussion have their own metadata that allow those individual message to be discoverable individually but in the context of the broader discussion.

Stages 330 and/or 338 represents examples of the persistence of metadata in one embodiment of collaboration system 102, with metadata being inherited by a communication from related attachments, and/or metadata being inherited by a discussion from linked communications in the discussion.

It will be understood by the reader that the use of metadata, and particularly persistent metadata accumulated by system 102 in a centrally managed process, is a useful feature of the invention and provides many benefits in managing communications as described herein.

In some embodiments, there may be different levels of metal-data, and there may exist any suitable relationship between the different levels. For example in one of these embodiments, there may be schema hierarchy including a global schema, and any number of asset class schemas and implementation schemas.

In optional stage 340, the form of the communication is adapted to the format used for making the communication available, for example by communication form adaptor 216. For example, in one embodiment all forms of communication may be standardized to accommodate the output interface used by the particular embodiment (e.g.—a text transcript of an audio file). As another example, in one embodiment all communications are adapted so the communications are made available in stage 342 in a similar format regardless of the actual form of the message recognized in stage 302. Continuing with the example, real time and non-real time messages may appear in the same mailbox. As another example, in one embodiment communications which are not in a predefined form that is valid under any conditions or valid based on the conditions prevailing at the time of the communication may be converted into one of the allowable predefined forms. Continuing with the example, if only non-real time message are allowable, real time messages may be converted into a non-real time message format.

In stage 342 the communication is made available to participants to the communication, for example when participants access, via network interface 104A, the communication that is stored for example in database 114. In one embodiment, as mentioned above one of the one or more participating entities to which the communication is made available is the requesting entity. Method 300 then ends.

It will be appreciated that, in accordance with a significant advantage of the present invention, the communication is manipulated centrally at collaboration system 102, for example in accordance with method 300, and made available to participants to the communication who access central collaboration system 102. Rich and persistently stored metadata may be used to facilitate communications. In one embodiment, the connections between messages may be visually made apparent, and communications of different types may be linked.

FIG. 4 illustrates a GUI 400 for making the communication available to a particular participating entity, according to an embodiment of the present invention. In the illustrated embodiment “discussions” entry 402 may be selected in order to view communications participated in by the particular participating entity. In the illustrated embodiment, all messages whether originating with the participating entity (i.e. the participating entity was the requestor) or not are shown in the same message box screen 416. Therefore in this embodiment, the requestor is noted in column 410 but communications in message box screen 416 are not physically separated based on who is the requesting entity. In the illustrated embodiment, the category 404 of each communication is listed, for example in accordance with the determination of stage 310. In this embodiment a selected communication 406 is highlighted and details of the selected communication are shown in screens 412 and 414. In the illustrated embodiment the linkage of messages including communication 406, for example which may have occurred in accordance with stage 338, is shown in discussion screen 408. In the illustration each linked message is shown as a separate entry on the discussion screen 408. In an alternative embodiment, the name of the discussion may also or alternatively be listed in a separate column in message box screen 416. In one embodiment attachment references are displayed with the threaded communications as part of a discussion thread.

In some embodiments, messages in message box screen 416 can be displayed in different ways depending on a selection by the entity that is viewing message box screen 416. The selections can include for example, ungrouped messages, messages grouped by discussion, messages grouped by category, messages grouped by date, messages grouped by requestor, etc.

In some embodiments, not all messages may be displayed in message box screen 416. For example in one embodiment, only recent messages are displayed (where the time span defined by “recent” may be selected by the viewer, by collaboration system 102, or by a combination of the two—for example where the viewer is provided a limited number of choices pre-selected by system 102). As another example, only messages belonging to one or more categories (selected by the viewer, collaboration system 102 or a combination of the two) are displayed.

As mentioned above, in stage 304, one of the relevant characteristics which may be determined is whether the requester is currently working in a collaborative or private workspace. More information on workspaces according to an embodiment of the present invention will now be provided.

A workspace is a named collection of named pages. Each page is made up of configurable information, presentation, application, and communication components. A workspace can be a fixed place in an implementation of the invention, or a virtual place, for example embodied/contained by an active discussion that includes multiple attached content set, people, and services. A workspace can be created in advance of their use, or can be created dynamically on an as needed basis.

Entities can self aggregate into groups for sharing information with everyone in the group. The entities that belong to a workspace are called workspace members.

The two types of workspace pages relevant to the present invention are private pages and collaborative pages. A private page is an electronic workspace where an entity using a workspace can place content that is not meant to be shared with other workspace members. There can be multiple private pages, and they can be constructed of any components that that entity has rights to use. Private pages allow the use of components (e.g. Messaging) that exchange content with entities that are not workspace members. Content can be sent from a private page to a collaborative page if it is found to be of value broadly.

A second type of workspace page available within the system is a collaborative page. Collaborative pages are visible to all members of the corresponding collaborative workspace. A collaborative page can be made up of any configurable components an entity has rights to, but in one embodiment content/messages/information found on a collaborative page cannot be shared with anyone that is not a workspace member, that is, enabled with permission to view the workspace.

In one embodiment, every registered entity at least has a private workspace. Each entity has the right to configure that private workspace.

In one embodiment, any registered entity of collaboration system 102, can create a workspace (or multiple workspaces). The entity/ies who create the workspace, are called the workspace owner(s). (The singular form of owner is used below to include one or more owners). Once created, the workspace owner can invite other registered entities of collaboration system 102, or possibly even other entities which are not registered to share that workspace with them. Any entity that accepts the invitation to join the (collaborative) workspace will find, upon logging on to collaboration system 102, that collaborative workspace visible to that entity.

In one embodiment only the workspace owner can invite people to join a collaborative workspace. The workspace owner can also remove existing members from a collaborative workspace, and workspace members can also remove themselves. When the owner of a workspace invites other members and they join, every existing member provided with access to that collaborative workspace is informed of the new member. The workspace owner can give invited members specific rights within the collaborative workspace. For example, certain members may have ‘read only’ privileges. Others may have the rights to add new collaborative pages to the collaborative workspace.

In one embodiment, the owner can only invite entities who allow the owner access (see below for details on permitting access with reference to FIGS. 8 and 9) to join the workspace whereas in another embodiment the owner can invite any registered entity and/or other entities to join the workspace.

As mentioned above with reference to stage 336, metadata related to a requesting entity and/or participating entities may be associated with a communication. As mentioned above with reference to stage 310, participating entities can predefine categories for categorizing messages addressed to the participating entities. FIG. 5 illustrates a GUI 500 for inputting information on an entity including categories for categorizing messages addressed to that entity, according to an embodiment of the present information. The invention is not bound by the format and/or content of the illustrated GUI 500.

For example, in one embodiment GUI 500 includes personal contact section 502, business address information 504, (interest) category section 506, phone section 508, and internet section 510. In one embodiment, the number of categories which may be added and listed in category section 506 is not constrained.

In accordance with a key feature of one embodiment of the invention, information inputted by an entity, for example via GUI 500, enables an entity to locally establish relevant information in the form of persistent metadata for use by itself and others in the operation of the invention described herein. As will be understood by the reader, this provides the significant advantage of enabling each individual entity of the system to establish a persistent persona. In another embodiment, an entity can establish relevant information for itself or for other entities using separate GUI 500 for each separate entity.

In one embodiment, the entity information, inputted for example via GUI 500, is converted into persistent metadata in accordance with predetermined schema. This persistent metadata, established in accordance with the predetermined schema, is available for use within collaborative workspace system 102.

Some or all of the information inputted via GUI 500 may be associated in stage 336, possibly with other information, as metadata for communications to which that entity is a participating and/or requesting entity.

In another embodiment, one of the categories pre-defined by an entity, for example via category section 506, is used in stage 310 to categorize communications addressed to that entity. In one embodiment, even if an entity comprises more than one individual, messages are categorized in accordance with predefined categories for that entity.

As mentioned above with respect to stages 306, 318 and 308, in some embodiments, collaboration system 102 only accepts inputted participating entities who allow access by the requestor or checks inputted participating entities to verify that the entities allow access by the requester. More details according to one of these embodiments are now elaborated on.

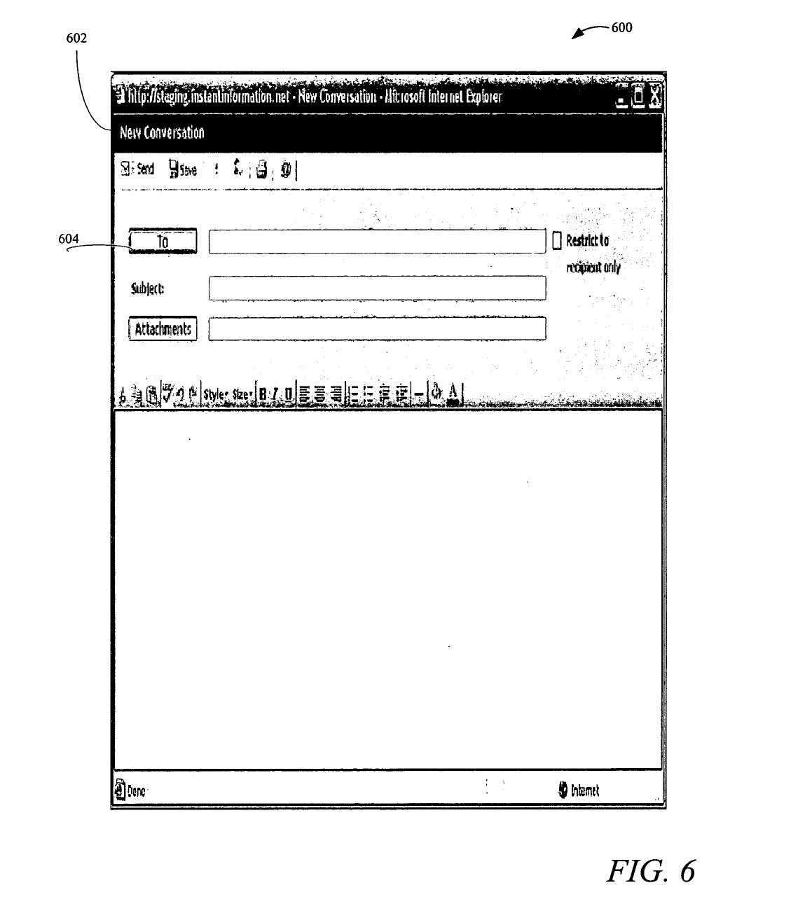

Refer to GUI 600 illustrated in FIG. 6 for inputting a message which is not linked to any previous messages, according to an embodiment of the present invention. The invention is not bound by the format and/or content of the illustrated GUI 600. The title “new conversation” 602 indicates a message not linked to any previous messages (i.e. a new discussion). If the requesting entity selects the “to” button 604, in one embodiment a second GUI 700 is displayed.

FIG. 7 shows GUI 700 in accordance with an embodiment of the present invention. The invention is not bound by the format and/or content of the illustrated GUI 700. Contact column 702 lists all entities who allow access by the requester (i.e. entities who are allowable participants for communications from the requestor). In the illustrated example, only one entity “John Mahoney” allows access by the particular requestor, however it will be understood that any number of allowed contacts may be listed. Interest category column 704 has a drop down menu for each contact entity which allows the selection of an appropriate category for the communication (where the categories for example were pre-established through box 506—see above discussion of FIG. 5). Address column 706 can be configured to optionally show the email address (and/or any other relevant contact information) of the contact entity, or contact information may be blocked. Therefore, in the illustrated embodiment because only John Mahoney is listed as a contact, the requestor could only input John Mahoney in stage 306/318 or in stage 308 only John Mahoney would be considered an allowable participant for a message from the requestor.

A description of how to add entities to contact column 702 will now be expanded upon, according to an embodiment of the present invention. Suppose the requestor wishes to have access to a specific entity or contact. In one embodiment, the permission to access is mutual, that is, if the specific entity grants the requester the right to access the specific entity, the specific entity is automatically granted the right to access the requestor. In another embodiment, the permission is not necessarily mutual. In yet another embodiment, if a specific entity grants the requester the right to access the specific entity, the specific entity is also granted the right to access the requester but not necessarily at the same level of access—a different level of access (or visibility to the information) may in some cases be offered.

In one embodiment, permission to access includes all forms of communication whereas in another embodiment permission to access can in some cases differentiate between different forms of communication, for example real time communication and non-real time communication. In one embodiment, permission to access a specific entity is granted in a general fashion, i.e. under certain circumstances the requestor has permission to access the specific entity, but not necessarily under all circumstances. In another embodiment, if permission is granted to access a specific entity, the permission is valid under all circumstances, at least for one form of communication.

FIG. 8 shows a GUI 800 listing a partial directory of assets of collaboration system 102, according to an embodiment of the present invention. The invention is not bound by the format and/or content of the illustrated GUI 800. In one embodiment, different types of assets from the directory may be listed on the same screen, whereas in another embodiment, assets of different types from the directory are listed on separate screens. Every entry in the directory has at least one owner responsible for the asset it represents. In some embodiments every directory entry further contains permissions associated with it. In some of these embodiments these permissions describe one or more of the following inter-alia: the visibility of the entry itself to a particular entity searching in the directory; provided the particular entity can view the entry, the metadata that is visible to that particular entity; and the access/permission level to the asset described by the entry to the particular entity viewing the entry. For example in one of these embodiments, possible permission/access levels include one or more of the following inter-alia: ‘right to access’, ‘right to request access’, and ‘no access’. More granular levels of permission are supported as required by specific uses of both the invention and specific assets.

In one embodiment assume a requesting entity discovers an asset in a directory that the requesting entity wishes to have access to, the requesting entity can request access from the owner of the asset. If the entity has been assigned a ‘right to request access’, a request, including details about the requesting entity, will be sent to the owner of the asset. In one embodiment, if the entity has been assigned a ‘right to access’, the entity will have the right to ‘subscribe’ to the asset, and access will be granted to them immediately. In another embodiment, once an entity has been assigned a right to access, a subscription to the asset is also included.

Continuing with the example, assume that assets include inter-alia registered entities to collaboration system 102, where the owner of each entity is the entity itself. For ease of explanation, it is assumed in the description herein that permission to access a registered entity (the asset) inherently includes a subscription to the asset, but in embodiments where permission to access and subscription are separate, similar methods and systems to those described herein may be used mutatis mutandis.

Specifically for this example assume that the requesting entity desires to access a specific entity (asset) 802 (here assumed to be Isaak Karev) and therefore clicks on specific entity (asset) 802 in GUI 800. In one embodiment, an asset profile GUI 900 of specific entity 802 will be displayed.

In one embodiment of the invention, FIG. 9 shows an asset profile GUI 900, according to an embodiment of the present invention. The invention is not bound by the format and/or content of the illustrated GUI 900. Section 902 shows that entity 802 does not permit the requesting entity to contact entity 802 via instant message. Section 904 shows that entity 802 does not permit the requesting entity to contact entity 802 via a (non-real time) email message. In other embodiments, other forms of communication and permission levels may be displayed. For example, in one of these other embodiments, permission to receive updates/changes to metadata describing entity 802 (including inter-alia updates/changes to presence management of entity 802) may be displayed. In other embodiments, one permission level for all forms of communication may be displayed. In other embodiments, permission levels dependent on circumstances such as for example time of day, presence of another entity, current tasks of entity 802, etc, as established by presence management 124 may be displayed. In the illustrated embodiment it is assumed that the permission denotes a general permission, i.e. whether access permission is allowed on a general basis, i.e. at least under some circumstances for that form of communication but not necessarily under all circumstances for that form of communication.

In the illustrated embodiment button 906 enables the requesting entity to request access to specific entity 802 from specific entity 802 (the owner). In one embodiment, pressing button 906 brings up a GUI allowing entry of a special request access message to entity 802. In one embodiment the special request access message is made available to the requesting entity and/or specific entity 802 in a separate GUI and not in the GUI which holds other messages (such as GUI 416).

In one embodiment, if the requesting entity does not have permission to request access to entity 802, then button 906 would not appear on GUI 900 presented to the requestor

Once access has been requested, for example via request button 906, the owner can choose to grant or deny access, and define a term and/or other circumstances. The requesting entity will receive a message informing him of the result of the request. If permission to access is granted, then in one embodiment specific entity 802 under qualifying circumstances may be specified as a participating entity by requesting entity in stage 306/318 or may be considered allowable in stage 308. If the request was rejected, the requesting entity may be precluded from asking for access to the asset again for the term defined (if any).

Access to any asset can be commercialized. This includes access to entities and applications as well as the more traditionally considered content.

In one embodiment if the requesting entity is granted access to specific entity 802, the new relationship between specific entity 802 and requesting entity is noted by collaborative system 102. For example the specific entity may be considered a contact of the requesting entity and may be listed for example in column 702 of GUI 700 with whatever details about that other entity that the requesting entity is granted visibility to.

Any updates or changes to an entity or to the metadata describing the entity is in one embodiment immediately made available to those granted access to that entity. As one example, any changes that specific entity 802 makes to a personal profile for example via GUI 500 will immediately be available to anyone that has been granted access (for example a requestor who has been granted access), and the changes will appear for example when those granted access views details on specific entity 802 for example by pressing properties button 708 of GUI 700 (assuming specific entity 802 has been added), by accessing GUI 900. As another example, changes to presence management 124 for entity 802, made for example via method 1100, may be made available. Alternatively any changes will be made available both to those who have been granted access to the entity as well as to those who only have permission to view the personal profile. As another alternative changes or updates will be made available to those granted access with a permission level corresponding to viewing the changes/updates. Alternatively or in addition, changes or updates may be made available via an explicit message sent by collaboration system 102 to those granted access, those with permission to view the personal profile and/or those with a permission level corresponding to viewing the changes/updates.

In one embodiment, if the requesting entity has been granted full access to specific entity 802, when the requesting entity is presented with GUI 900, section 902 and 904 instead show “yes”, and request button 906 does not appear. If only partial access has been granted, and either section 902 or 904 show “no”, in one embodiment request access button 906 is present but restricted to the form of communication for which access has not yet been granted. In one embodiment of the invention, pressing the properties button 708 of GUI 700 and/or clicking on the name of entity 802 on some GUIs also brings up GUI 900 with these changes.

As mentioned above, for example with reference to stages 308 and 314, in some cases access to a participating entity is allowed or not allowed depending on the prevailing circumstances, in accordance with the rules of presence management for that participating entity. More details are provided below. It will thus be understood by the reader how the system in accordance with the present invention manages communications between entity users of the system.

FIG. 10 is a block diagram of presence management tools 124, according to an embodiment of the present invention. As used herein and as further described below, presence management refers to the management of an entity's ‘presence’ or indication of active usage of the system. Presence management tools 124 can be made up of any combination of software, hardware and/or firmware that performs the functions as defined and explained herein. In the illustrated embodiment, presence management tools 124 include parameter 1 setup module 1051 through parameter N setup module 105N, selection and prioritization of parameters module 1004, one or more data collections 1006 (for example, entities lists, communication forms list, calendar, etc), rules storage 1010 and access gatekeeper 1012. Depending on the embodiment, an entities lists as part of data collection 1006 can comprise a generic list of entities, for example all registered entities, or can be tailored for a particular entity, for example comprising those entities which are allowed access to the particular entity under some circumstances but not necessarily under all circumstances. Each of modules 1051 . . . 105N, 1004, 1006, 1008, 1010, and 1012 can be made up of any combination of software, hardware and/or firmware that performs the functions as defined and explained herein. In other embodiments, presence management tools 124 may include other modules illustrated or not illustrated in FIG. 1 as being elsewhere in system 100. For ease of understanding modules 1051 . . . 105N, 1004, 1006, 1010, and 1012 have been presented as being a part of presence management tools 124 but in other embodiments any of modules 1051 . . . 105N, 1004, 1006, 1010, and 1012 may be integrated with workspace tools 122, personal metadata management tools 120, messaging tools 118, processor 110, and/or database 114. For example in one embodiment, the functionality of participant(s) sensor 204 is integrated with presence management tools 124. As another example, rules storage 1010 and/or data collection(s) 1006 may be integrated with database 114.

FIG. 11 is a flowchart of method 1100 for managing presence, according to an embodiment of the present invention. In one embodiment, method 1100 is executed by presence management tools 124. In one embodiment method 1100 is executed for each registered entity at the time of registration and repeated upon request or when required, for example because of changes to collaborative system 102 made by the registered entity, made by another entity or system generated. In another embodiment method 1100 is executed only for certain entities, for example entities which request or require presence management. In another embodiment, method 1100 can be executed the first time an entity accesses collaboration system 102, whether registered or not. Registration by entities can be accomplished through any means, for example by self-signup. The invention is not bound by the specific stages or order of the stages illustrated and discussed with reference to FIG. 11. Alternative embodiments can include only selected stages from the illustrated embodiment of FIG. 11 and/or additional stages not illustrated in FIG. 11. In the description below it is assumed that presence management is being set up by one of the participating entities determined in stage 306/318, for example specific entity 802.

In stage 1102, relevant parameters are determined. For example the participating entity for whom presence management is being set up or amended can be asked to select parameters upon which the participating entity wishes the presence management to be based. In some embodiments, some of the parameters may always be included regardless of the selection by that participating entity. For example in one of these embodiments the presence/absence of the participating entity may be automatically considered a relevant parameter.

Depending on the embodiment relevant parameters may include one or more of the following inter-alia: presence/absence of the participating entity, presence/absence of another entity, time of day, date, task currently working on (for example service currently using, what workspace page currently working in), the number of total previous interruptions by any requesting entities, a characteristic of the requesting entity, and the characteristic of a relationship between the requesting entity and the participating entity (for example business versus personal relationship, compensation level, the number of times the requesting entity has already contacted the participating entity in a predetermined time interval, etc.). Other parameters for managing presence will now be apparent to the reader.

In stage 1104, prioritization of the relevant parameters are determined, for example by selection and prioritization module 1004. For example in one embodiment the participating entity can decide on the prioritization. In another embodiment the prioritization may be fully fixed by collaboration system 102 or partially fixed by collaboration system 102 and partially decided upon by the participating entity.

In stage 1106, each relevant parameter is set up, for example by modules 105-1 . . . 105-N. In one embodiment the parameters are set up in decreasing order of priority for various requesting entities and/or forms of communication. In one embodiment, the various requesting entities included in the setup are those requesting entities which are allowed access to the participating entity on a general basis, i.e. those requesting entities who under some circumstances but not necessarily under all circumstances can access the participating entity. In one embodiment, the setup is only for real time communication, whereas non-real time communication is allowed by all requesting entities which have been allowed access to the participating entity on a general basis.

The set up of each parameter may be performed in a user friendly manner. For example, assuming the participating entity is performing the setup, the participating entity can be asked questions such as “would you like your communications blocked if your secretary is available?” or “would you like access by requesting entities to be limited to collaborative workspace members when working in that workspace?”. “Would you like to be available to requesting clients whose hourly rate is above a certain amount and if yes state the amount”. As another example, a calendar as part of data collection 1006 can be presented to the participating entity and block-out times for some or all requesting entities can be noted by the participating entity. In addition or alternatively, the participating entity can be asked for example if the participating entity wants to be accessible during times in which events/meetings are scheduled. In addition or alternatively, the participating entity can be asked for example if the participating entity wants to limit the number of interruptions by a particular entity or by all entities during given time blocks on the calendar. As another example, an entities list as part of data collection 1006 can be presented to the participating entity and the participating entity can for example select entities which are selections in the parameter setup (for example in one embodiment all workspace members may be selected as a group item shown on an entities list as part of data collection 1006) and/or exceptions in the parameter setup. As another example, a communications form list as part of data collection 1006 can be presented to the participating entity and the participating entity can select forms of communication which are governed by the parameter setup (for example real time versus non-real time communications).

In one embodiment the setup of some or all relevant parameters are automatically executed by presence tools 124 and do not require participating entity input. For example, there may be default values for parameters which are used unless overridden by the participating entity.

In one embodiment the execution of stages 1102, 1104 and 1106 establishes one or more rules of access to the participating entity by one or more requesting entities using one or more forms of communication.

In stage 1108, the established rules are stored, for example in rules storage 1010. The rules may be stored, for example, in an easy to read table cross referencing the relevant parameters with entities and/or forms of communication.

In one embodiment, any establishment of rules or changes to existing rules for a participating entity which impact any other entities are indicated to the impacted entities, for example by a system 102 generated message. For example if rules for a participating entity now forbid real time access if the assistant of the participating entity is also available, all entities may be informed of this change in this embodiment. In another embodiment, only those entities which have requested and/or received access to the presence management of a particular participating entity are informed of all changes to the rules for the particular participating entity or of all changes to the rules which impact the subscribed entities (see above description with reference to FIG. 9).

In stage 1110, access gatekeeper 1012 allows or blocks access to the participating entity in accordance with the one or more stored rules. In one embodiment, stage 1110 is repeated each time a requesting entity requests access to the entity for which presence management has been set up for example in stages 306/318, 308 and/or 314. In other embodiments only certain forms of communication are blocked by the rules, access gatekeeper 1012 which may prompt the requesting entity whose form of communication is blocked to use a different form of communication, may automatically convert the communication to an allowable form of communication as explained above with reference to stage 340, or may block the requesting entity, optionally notifying the requesting entity of the reason for the block.

In one embodiment, access gatekeeper 1012 allows or blocks access to the participating entity in accordance with one or more stored rules established by the participating entity and one or more stored rules established by the requesting entity. In this embodiment, requesting entities also establish rules for when messages are allowed to be sent, for example lower priority messages may be set up so that the messages are sent during low load periods.

For the sake of further illustration of method 1100, an example is detailed now. The described parameters and setup of this example should not be construed as typical nor comprehensive. In this example assume that the relevant parameters are: presence of the participating entity, presence of the secretary of the participating entity, time of day/date, workspace currently working in, and the priority of the relationship. Also assume that only real time access is determined by presence management tools 124 whereas non real time communication is allowed as long as access has been granted (see above discussion with reference to FIGS. 8 and 9).

In this example, the presence of the participating entity is considered top priority (i.e. if participating entity is offline then real time access is never allowed), the relationship priority is next in priority (i.e. if participating entity is online and the requesting entity is an important client or customer, then real time access is always allowed), the presence of the secretary is third in priority (i.e. if participating entity is online and secretary is online and requesting entity is not a high priority client then real time access to entity is not allowed because access to secretary is available), time of day/date is next in priority (i.e. if participating entity is online and secretary is offline and requesting entity is low prioirty and the time is between 10-12 on a Wednesday, then real time access to participating entity is not allowed by anyone other than Bob), and workspace currently working on is last in priority (i.e. if participating entity is online and secretary is offline and the requesting entity is low priority and the time is not between 10-12 on a Wednesday, then real time access to participating entity is allowed only to members of collaborative workspace in which participating entity is currently working in.)

Continuing with the example, the presence described management setup can be performed, for example, in the following manner: First the presence of the participating entity is automatically set up by entity presence setup module 1051 so that any real time messages are not accepted if the participating entity is offline. Second the participating entity can be presented with a forms of communication list as part of data collection 1006 and asked to select which forms of communication will conform to the parameter setup and/or which forms of communication are always allowed to be used to access the participating entity (for example by those who have permission to access the participating entity as explained above with reference to FIGS. 8 and 9). Third, exceptions setup module 1052 is set up with the participating entity asked if there are certain requesting entities who are exceptions and should always be able to access the entity regardless of the parameter setup. If yes, an entities list as part of data collection 1006 can be presented and the participating entity can select the exceptions or the participating entity can establish criteria to determine the exceptions.

The criteria can be based for example on a characteristic of the exception entity and/or a characteristic of the relationship between the exception entity and the participating entity (for example all clients paying over $500/hour are high priority clients). Fourth backup presence setup module 1053 is setup with the participating entity asked if the participating entity would prefer not to receive the setup-conforming forms of communication from non-exception entities if a backup entity is available (where available can mean online, not occupied in a certain task, not blocking all or certain messages, etc depending on the embodiment). If the participating entity answers yes, an entities list as part of data collection 1006 can be presented to the participating entity and the participating entity can choose one or more entities as backups who if available would cause setup-conforming forms of communication to be blocked from the participating entity (other than from the exceptions).

In desired circumstances, exceptions to the backup presence parameter setup can be established by selecting from an entities list as part of data collection 1006 those entities whose communications are not blocked even if the backup entity (ies) is available. Fifth, time-based setup module 1054 is setup with the participating entity is asked if there are times of day, days of week, dates of month, time-based events (for example any meetings/events scheduled on calendar) when access should be blocked even if the backup entity is not available (assuming the participating entity would prefer not to receive communications if the backup is available). For example, a calendar as part of data collection 1006 can be presented to be filled in by the participating entity. In some cases, exceptions to the time based parameter setup can be established by selecting from an entities list as part of data collection 1006 those entities whose communications are not blocked even during one or more of the blackout times.

Sixth, task setup module 1055 is setup with the participating entity asked if even during the non-blackout times when the backup entity is not available (assuming the entity would prefer not to receive communications if the backup is available) access should be limited depending on the task performed. For example, each possible task can be presented and the participating entity can select those tasks during which access should be constrained. The participating entity can then for each constrained task select exceptions using an entities list as part of data collection 1006, if desired. For example, in one embodiment each private and collaborative workspace of the participating entity can be presented and the participating entity can select whether access is constrained or not. In this embodiment, for example, access can be restricted to only members of the same collaborative workspace which the participating entity is working in.

It will thus be understood by the reader that a significant feature of the present invention is the ability for a user entity to manage their presence, which is the ability for others to see their active use of the system and communicate with them.

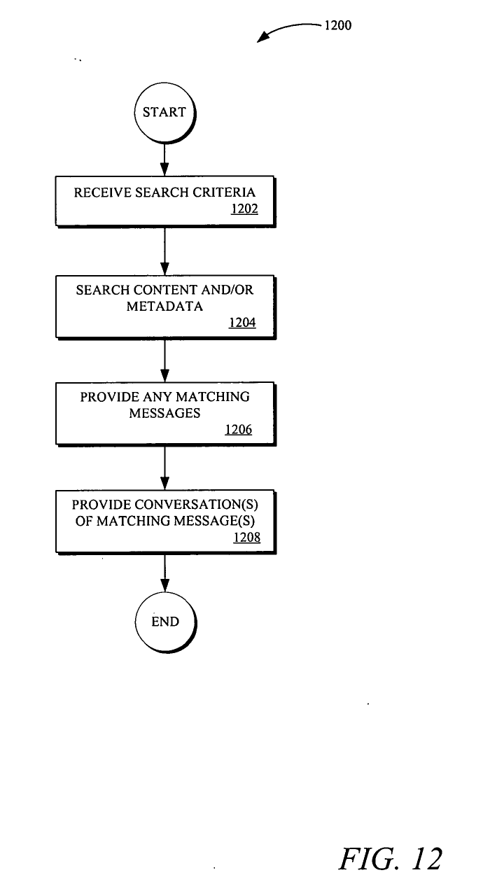

FIG. 12 is a flowchart of a method 1200 for searching through communications which are stored for example in database 114, according to an embodiment of the present invention. Method 1200 can be executed for example by searcher 214. The invention is not bound by the specific stages or order of the stages illustrated and discussed with reference to FIG. 12. It should also be noted that alternative embodiments can include only selected stages from the illustrated embodiment of FIG. 12 and/or additional stages not illustrated in FIG. 12.

In stage 1202, one or more search criteria are received for example from a searching entity via network interface 104A. The criteria can relate to one or more of the following inter-alia: subject content, title content, message body content, text indices of any attachments, attachment content, metadata associated with the attachment, metadata related to the message for example synopsis and/or keyword, metadata related to the requesting entity, metadata relating to participating entity(ies), text index of the message, any standard tags such as industry classification, ticker codes etc., event(s) that have the same class of metadata, time and location related metadata and a combination of any of the above. For example, the search request can state find all messages that were sent to me from someone with an expertise in technology and contain the phrase “Internet Bubble”. Other search criteria will now be apparent to the reader.

In stage 1204 the messages are searched in accordance with the search criteria received in stage 1202. In stage 1206, any matching messages are provided for example via network interface 104A to the searching party, for example entity.

In one embodiment, because the metadata related to an attachment is associated with a message, for example in stage 330, the usage of search criteria related to related to an attachment will cause the retrieval of the message

Depending on the embodiment the search request can be limited to one or more workspaces (private and/or collaborative) or can include all workspaces of an entity. Depending on the embodiment, the search request can be limited to certain messages within the searched workspace(s) or can include all message within the searched workspace(s). For example in one embodiment only messages from a given time period or from a certain batch (for example last 100 messages) are searched, whereas in another embodiment all messages regardless of time period or batch are searched. As another example in one embodiment only messages in a given category are searched whereas in another embodiment all messages from any category are searched.

In optional stage 1208, the discussions if any to which the matching message(s) belong are also provided. For example in one embodiment, any messages connected in discussion are provided if the matching message in that discussion is selected and/or opened up.

There has thus been provided a new and improved workspace collaboration system. The system comprises an ASP solution while providing each entity significant flexibility in customizing it to their own use. The described system further provides for the inclusion of a rich and persistent metadata with substantially every system asset. Various search, subscription, filtering and interest functionalities make use of the persistent metadata so as to make information assets easy to find and use. The described system has application in the field of information technology, and particularly in the field of collaborative workspace management. In comparison to the prior art:
The described system provides a directory and permission framework that can operate cross enterprise, allowing individuals at different firms to work together and exchange content.
While being developed and maintained by a remote ASP, the described system is ‘edge configurable’. Beyond defining new entities and their commercial rights, every other dimension can be configured by individual entities and requires no central authority. Authorized entities can self publish, self aggregate, self subscribe, self describe, and self permission.
The described system preserves deep and rich metadata across all uses of content. It is also associative. A message that is sent with a document attached to it has its own metadata, the attached document's metadata, and metadata about the participating entities associated with it. This enables deeper use of content then is possible with other collaboration systems. (e.g.—A person could find any messages they sent to people in Chicago in the last two months that had documents attached that were about the CBOT. A person could open a message with a document attached about Microsoft, and have a link automatically appear to their internal expert on Microsoft.)
The described system maintains a centralized descriptive directory of all assets know to the system. Assets include people, content, application components, and data sets.
The described system provides a framework where entities can permission access to themselves, and define their availability using an enhanced presence model.
The described system allows entities to advertise what classifications they would like to have associated with message others send to them. This places the first level filtering burden off of the message participating entity and on to the message requestor where it more appropriately belongs.
The described system provides a framework for the commercialization of person to person interactions and access. An authorized entity could add a commercial intermediary to charge another entity for the to access them via IM, telephony, or messaging
The described system allows entities/publishers to define their own descriptive schemas at the content level, while maintaining visibility in an aggregated space via high level common and domain specific tags.
The described system allows the usage of detailed publisher defined schemas for discovering content via searching and filtering, and combines it with tools for organizing this discovered content into local taxonomies express within user defines folder structures.

While the invention has been shown and described with respect to particular embodiments, it is not thus limited. Numerous modifications, changes and improvements within the scope of the invention will now occur to the reader.

What is claimed is:

1. A method of communicating, comprising:
receiving a first communication from a requesting entity;
determining any participating entities to whom said first communication is to be made available;
storing said received first communication and metadata relating at least to said determined participating entities; and
making said stored first communication available to said determined participating entities.

2. The method of claim 1, further comprising:
receiving a second communication related to said first communication;
linking said second communication and said first communication in a discussion;
associating meta-data from said first communication and said second communication with said discussion;
storing said second communication; and
making said stored second communication available in a format which indicates that said second communication is associated with said first communication.

3. The method of claim 2, wherein said second communication is a reply to said first communication and said first communication and said second communication are displayed to said requesting entity in a same message box of said requesting entity.

4. The method of claim 2, wherein said first communication and said second communication use the same form of communication.

5. The method of claim 4, wherein said same form is selected from a group comprising:
electronic mail, instant message, and IP telephony.

6. The method of claim 2, wherein said first communication and said second communication use different forms of communication.

7. The method of claim 1, further comprising:
receiving an attachment with said first communication; and
associating meta-data relating to said attachment with said first communication.

8. The method of claim 1, further comprising:
receiving a request to search, wherein criteria for said search includes metadata associated with said first communication; and
providing search results including said first communication.

9. The method of claim 8, wherein said metadata associated with said first communication is metadata inherited from an attachment to said first communication.

10. The method of claim 8, further comprising:
providing search results including any other communications belonging to a same discussion as said first communication.

11. The method of claim 1, further comprising:
receiving a selection of a category for said first communication from said requesting entity, wherein said category is one of at least one category predetermined by one of said determined participating entities.

12. The method of claim 1, wherein said determining any participating entities includes:
receiving from said requesting entity a selection of at least one participating entity to whom said first communication is to be made available.

13. The method of claim 1, wherein said first communication is received while said requesting entity is working in a collaborative workspace and wherein said determining any participating entities includes:
determining at least one of said participating entities to whom said first communication is to be made available based on a characteristic of said collaborative workspace.

14. The method of claim 13, wherein said determined participating entity is a member of said collaborative workspace.

15. The method of claim 1, wherein said first communication is in a form acceptable to said determined participating entities.

16. The method of claim 1, wherein at least one of said determined participating entities has previously pre-approved having communications originating from said requesting entity being made available to said at least one determined participating entity.

17. The method of claim 1, wherein at least part of said associated metadata has been established by said determined participating entities.

18. The method of claim 1, wherein said associated metadata includes at least one selected from a group comprising: subject content, title content, message body content, text index of an attachment to said first communication, content of an attachment to said first communication, information associated with an attachment to said first communication, a text index of said first communication, keyword, synopsis, a standard tag, information related to said requesting entity, an event(s) having a same class of metadata, information related to time, and information related to a location.

19. A system for communicating, comprising:
means for receiving a first communication from a requesting entity;
means for determining any participating entities to whom said first communication is to be made available;
means for storing said received first communication and metadata relating at least to said determined participating entities; and
means for making said stored first communication available to said determined participating entities.

20. The system of claim 19, further comprising:
means for receiving a search request; and
means for providing search results including said first communication.

21. The system of claim 19, wherein said means for storing is operated by an application service provider.
